(19) United States
(12) Patent Application Publication
(10) Pub. No.: US 2019/0013833 A1
(43) Pub. Date: Jan. 10, 2019

(54) MOBILE ELECTRONIC DEVICE CASE ASSEMBLY

(71) Applicant: Quagga Accessories, LLC, St. Charles, MO (US)

(72) Inventor: Barry Horn, St. Charles, MO (US)

(21) Appl. No.: 16/011,298

(22) Filed: Jun. 18, 2018

Related U.S. Application Data
(60) Provisional application No. 62/530,646, filed on Jul. 10, 2017.

(51) Int. Cl. H04B 1/3888; A45C 11/18

(52) U.S. Cl. CPC H04B 1/3888; A45C 2001/065; A45C 11/182

(57) ABSTRACT

A case assembly includes a front portion and a back portion affixed with the front portion by an interface. The front and back portions are configured to move toward or away from each other about the interface. The assembly also includes one or more securing devices affixed with the back portion. The one or more securing devices configured to removably couple with one or more other securing devices on an electronic device. The one or more securing devices on the back portion are configured to hold the electronic device within the case assembly while allowing the electronic device to be separated from the case assembly.

### CROSS-REFERENCE TO RELATED APPLICATIONS

This application claims priority to U.S. Provisional Patent Application No. 62/530,646, which was filed on 10 Jul. 2017, and the entire disclosure of which is incorporated herein by reference.

### FIELD

The subject matter described herein relates to cases or covers for mobile electronic devices, such as mobile phones, tablet computers, or the like.

### BACKGROUND

A variety of protective cases are available to protect expensive mobile electronic devices, such as mobile phones and tablet computers. These cases typically are sized to fit only a single model of device. For example, the size of the case that fits an APPLE IPHONE 6S may not fit onto a SAMSUNG GALAXY S, an APPLE IPHONE 7, or the like. Similarly, the size of a case that fits an APPLE IPAD fourth generation may not fit onto another generation of the APPLE IPAD, an AMAZON FIRE tablet, or the like. As a result, users may be forced to purchase new cases every time a new model of a device is purchased. Additionally, some models of known cases can be difficult to take on or off the devices, which can result in the cases being broken or destroyed.

### BRIEF DESCRIPTION

In one embodiment, a case assembly includes a front portion and a back portion affixed with the front portion by an interface. The front and back portions are configured to move toward or away from each other about the interface. The assembly also includes one or more securing devices affixed with the back portion. The one or more securing devices configured to removably couple with one or more other securing devices on an electronic device. The one or more securing devices on the back portion are configured to hold the electronic device within the case assembly while allowing the electronic device to be separated from the case assembly.

In one embodiment, a case assembly includes a front portion and a back portion affixed with the front portion by an interface. The front and back portions are configured to move toward or away from each other about the interface. The assembly also includes one or more magnetic devices affixed with the back portion. The one or more magnetic devices are configured to magnetically couple with one or more securing devices on an electronic device. The one or more magnetic devices on the back portion are configured to hold the electronic device within the case assembly while allowing the electronic device to be separated from the case assembly.

In one embodiment, a case assembly includes a front portion and a back portion affixed with the front portion by an interface. The front and back portions are configured to move toward or away from each other about the interface. The assembly also includes one or more securing devices affixed with the back portion. The one or more securing devices are configured to removably couple with one or more other securing devices on an electronic device. The one or more securing devices on the back portion are configured to hold the electronic device within the case assembly while allowing the electronic device to be separated from the case assembly. The one or more securing devices affixed with the back portion are configured to be coupled with the one or more other securing devices connected with the electronic device using a fabric hook-and-loop connection.

### BRIEF DESCRIPTION OF THE DRAWINGS

FIG. 1 illustrates a perspective view of one embodiment of a case assembly for a mobile electronic device.

FIG. 2 illustrates a perspective view of the case assembly shown in FIG. 1 used in connection with another mobile electronic device.

FIG. 3 illustrates another embodiment of one or more securing devices shown in FIG. 1.

FIG. 4 illustrates another embodiment of one or more securing devices shown in FIG. 1.

FIG. 5 illustrates another embodiment of one or more securing devices shown in FIG. 1.

FIG. 6 illustrates another embodiment of one or more securing devices shown in FIG. 1.

FIG. 7 illustrates a flowchart of one embodiment of a method for providing a case assembly.

FIG. 8 illustrates a front view of another embodiment of a case assembly for the mobile electronic device shown in FIG. 1.

FIG. 9 illustrates an opposite rear view of the case assembly shown in FIG. 8.

FIG. 10 illustrates interior surfaces of the case assembly shown in FIGS. 8 and 9.

FIG. 11 illustrates a front view of one embodiment of a securing device for the electronic device shown in FIGS. 8 and 9.

### DETAILED DESCRIPTION

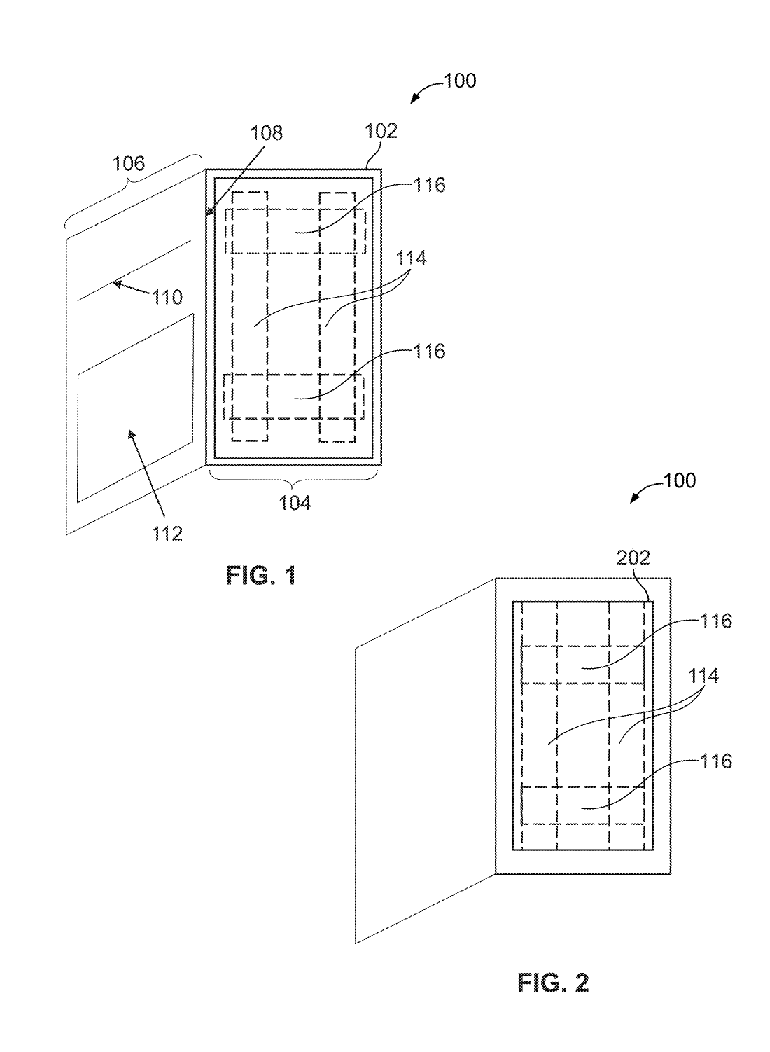

FIG. 1 illustrates a perspective view of one embodiment of a case assembly 100 for a mobile electronic device 102. The case assembly 100 includes a back portion 104 and a front portion 106 connected with each other along an interface 108. This interface 108 can be a seam, fold, hinge, or other connection. The device 102 can be a mobile phone, tablet computer, or other electronic device (e.g., a personal digital assistant) that is placed into the case assembly 100 between the front and back portions 106, 104 of the case assembly 100. The front and back portions 106, 104 can move or rotate toward each other (e.g., about the interface 108) to close onto the device 102 or to open and reveal the device 102. The front and back portions 106, 104 can be formed from leather, plastic, metal, or another material or combination of materials.

The front portion 106 of the assembly 100 optionally can include one or more pockets 110 and/or protected viewable areas 112 for holding other objects. For example, an identification card such as a driver's license can be received into the area 112 behind a light transmissive or transparent window so that the card is viewable. The pockets 110 can hold objects such as money, insurance cards, credit cards, debit cards, or the like.

The back portion 104 of the assembly 100 includes one or more securing devices 114. These devices 114 couple with one or more corresponding or complimentary securing devices 116 on an external surface (e.g., the back side) of the device 102. The securing devices 114, 116 can be removably coupled such that an ordinary human user of the assembly 100 can place the device 102 such that the securing devices 114, 116 come into contact and the securing devices 114, 116 couple with each other to prevent the electronic device 102 from separating from the case assembly 100 when the user no longer holds the electronic device 102 and the case assembly 100 together. In one embodiment, the securing devices 114 can be magnets or include magnetic material and the securing devices 116 can be a metal or magnet that magnetically couples with the securing devices 114. Optionally, the securing devices 114, 116 can be fabric hook-and-loop fasteners that couple the electronic device 102 in the case assembly 100.

As shown in FIG. 1, the securing devices 114, 116 can at least partially overlap each other to couple the electronic device 102 with the case assembly 100. The securing devices 114, 116 can be elongated bodies or have another shape. For example, one or more of the securing devices 114, 116 may have a shape closer to that of a square, circle, or the like.

The user can remove the electronic device 102 from the case assembly 100 by pulling the electronic device 102 away from the case assembly 100. This can break the coupling between the securing devices 114, 116 so that the electronic device 102 is no longer coupled with the case assembly 100. The coupling between the securing devices 114, 116 can be strong enough that the electronic device 102 does not separate from the case assembly 100 without the user pulling the electronic device 102 away from the case assembly 100, but can be weak enough to allow an ordinary or average human user to separate the electronic device 102 from the case assembly 100 without damaging or destroying the securing devices 114, 116, electronic device 102, and/or back portion 104 of the case assembly 100.

Optionally, the securing devices 116 on the electronic device 102 can be coupled with securing devices 114 on another assembly or component. For example, another case assembly may have the securing devices 114 for coupling with the securing devices 116 on the electronic device 102, a car mount assembly may have the securing devices 114 for coupling with the securing devices 116 on the electronic device 102, a recharging station of the electronic device 102 may have the securing devices 114 for coupling with the securing devices 116 on the electronic device 102, or the like.

The size and arrangement of the securing devices 114, 116 are provided as one example. Other options for the securing devices 114, 116 are shown and described herein. Not all embodiments of the inventive subject matter described herein, however, are limited by the depicted embodiments.

FIG. 2 illustrates a perspective view of the case assembly 100 used in connection with another mobile electronic device 202. The electronic device 202 can be a different shape or size than the electronic device 102 shown in FIG. 1. For example, the electronic device 202 may be smaller than the electronic device 102 due to the electronic devices 102, 202 being different models from the same manufacturer, being different devices 102, 202 from different manufacturers, or the like. The electronic device 202 can have securing devices 216 that are similar or identical to the securing devices 116 (shown in FIG. 1) of the electronic device 102, except for the securing devices 216 being a different size due to the different size of the electronic device 202.

The differently sized electronic devices 102, 202 (and/or other sized devices 102, 202) can couple with the same case assembly 100 due to the coupling between the electronic devices 102, 202 and the case assembly 100 not being dependent upon the size of the electronic devices 102, 202. For example, both the smaller and larger electronic devices 102, 202 can couple with and be secured within the case assembly 100. Optionally, one or more of the electronic devices 102, 202 can be coupled with the case assembly 100 in a position that results in at least part of a screen or other portion of the electronic device 102, 202 extending outside of and being visible outside of the front and rear portions 106, 104 of the case assembly 100 when the case assembly 100 is closed.

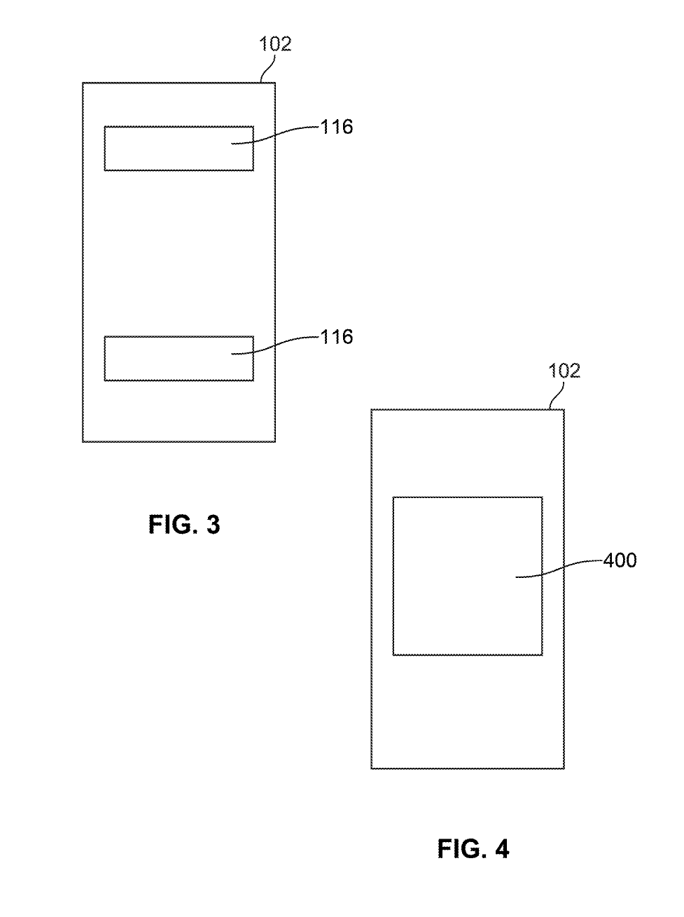

FIGS. 3 through 6 illustrate different embodiments of one or more securing devices 116, 400, 500, 600. Although FIGS. 3 through 6 describe optional versions of the securing devices 116 that are coupled with the back sides of the electronic devices 102, 202 (e.g., by an adhesive), optionally, these figures may depict the securing devices 114 that are coupled with the case assembly 100.

The securing devices 116 shown in FIG. 3 are elongated, vertically oriented bars of material, such as metal or magnetic material, or hook or loop material. Optionally, the securing devices 116 may be horizontally oriented bars. The securing device 400 shown in FIG. 4 is a single block of material, such as metal or magnetic material, or hook or loop material. The securing device 400 has a shape that is more square than rectangular (e.g., relative to the shapes of the bars shown in FIG. 3). Alternatively, the securing device 400 can have another shape, such as that of a circle, triangle, or the like. The securing device 400 can have a larger surface area than one or more other securing devices described herein to provide the user with more room for error in lining up the securing device 400 with the securing device or devices 114 of the case assembly 100.

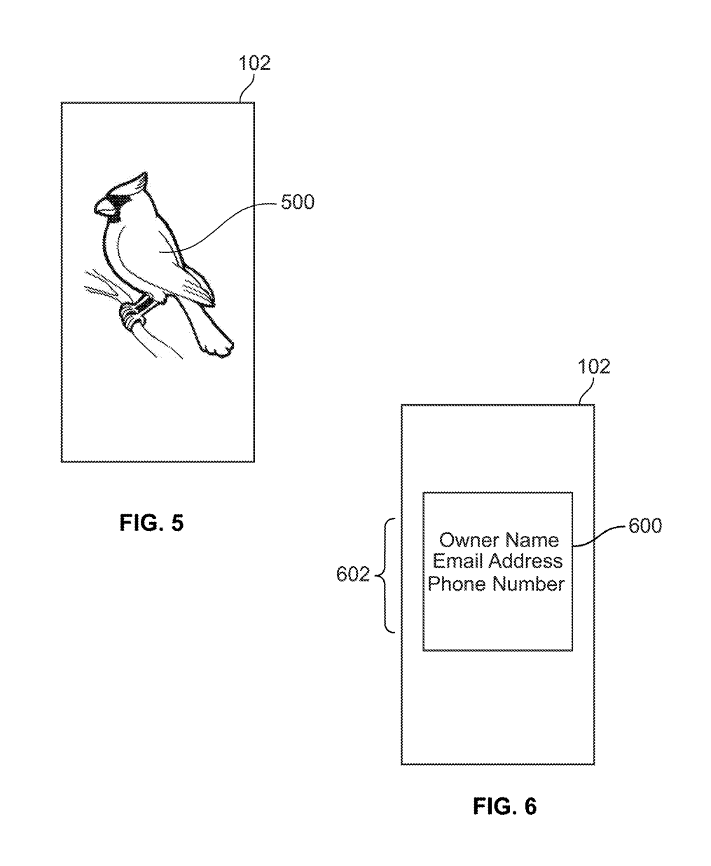

The securing devices optionally can have a shape or appearance of an animal, person, or other object, such as that of a sports mascot or symbol, a city skyline, a letter or number, or the like. The securing device 500 shown in FIG. 5 has the shape of a bird, such as a cardinal of the ST. LOUIS CARDINALS baseball team. The securing device 500 can be more decorative or aesthetically pleasing to the user than the rectangular or other shapes described herein. Users may prefer such securing devices 500 because the securing device 500 can be visible to others when the electronic device 102 is not coupled with the case assembly 100.

The securing devices optionally can present or list information. The securing device 600 shown in FIG. 6 is a block or layer of material with information 602 embossed into or printed on the material. This information 602 can indicate the owner and contact information of the owner of the electronic device 102 to assist in returning the electronic device 102 to the owner when lost. Optionally, the information 602 can indicate other information.

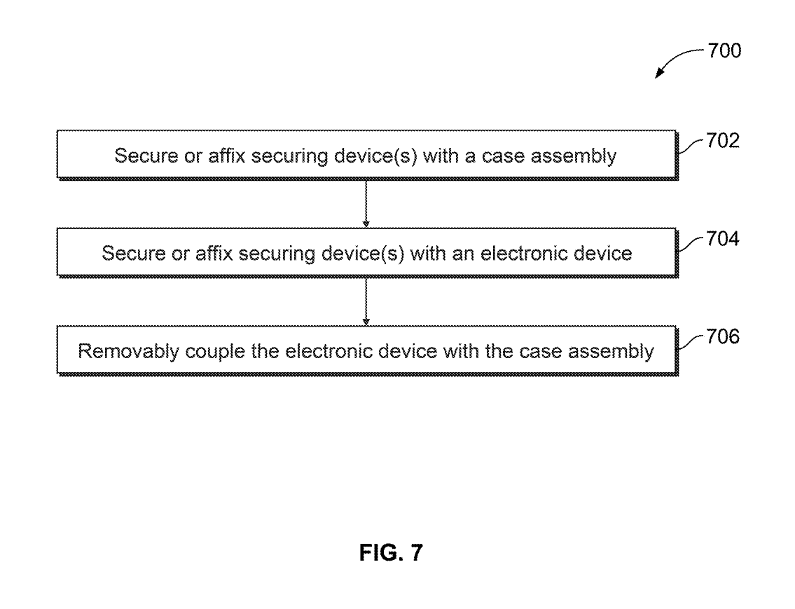

FIG. 7 illustrates a flowchart of one embodiment of a method 700 for providing a case assembly. The method 700 can be used to manufacture the case assembly 100 shown herein. At 702, one or more securing devices are coupled to the case assembly. For example, the securing devices 114 can be coupled with back portion 104 of the case assembly 100. The surface to which the securing devices 114 are coupled may not be visible when the case assembly 100 is closed. The securing devices 114 can be coupled with the case assembly 100 using an adhesive, by stitching the securing devices 114 into the case assembly 100, by placing the securing devices 114 inside the back portion 104, or the like.

At 702, one or more securing devices are coupled to an electronic device. For example, the securing devices 116 can be coupled with an exterior surface on a back side of the outer housing of the electronic device 102. The securing devices 116 can be coupled with the electronic device 102 using an adhesive.

At 704, the electronic device is removably coupled with the case assembly. For example, the securing devices connected with the electronic device can be brought into contact with the securing devices connected with the case assembly. The case assembly 100 can then be closed around the electronic device to protect the electronic device 102 when not in use. The case assembly 100 can be opened without detaching the electronic device 102 from the case assembly 100 when a user wants to use the electronic device 102. The user can separate the electronic device 102 from the case assembly 100 by moving the electronic device 102 away from the case assembly 100, such as to replace the case assembly 100, replace the electronic device 102, charge the electronic device 102, or the like.

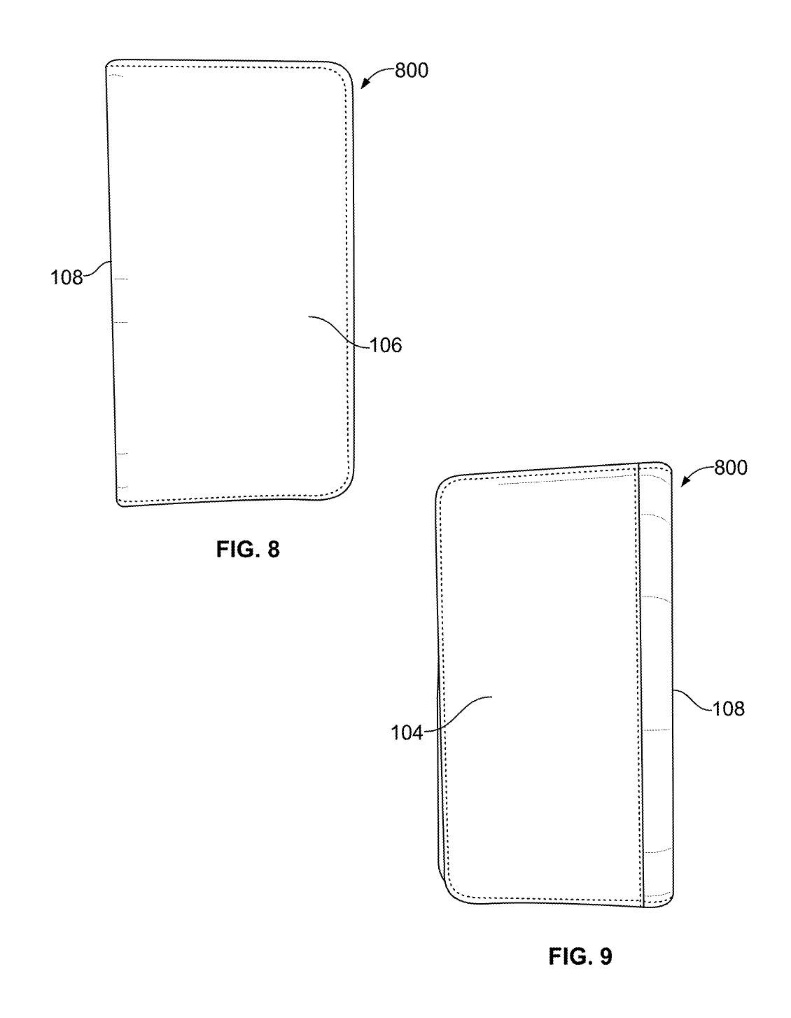

FIG. 8 illustrates a front view of another embodiment of a case assembly 800 for the mobile electronic device 102. FIG. 9 illustrates an opposite rear view of the case assembly 800 shown in FIG. 8. The case assembly 800 includes the back portion 104 and the front portion 106 connected with each other along the interface 108, as described above. The front and back portions 106, 104 may be flaps, planar bodies, or the like, that open and close about the interface 108. For example, the front and back portions 106, 104 can move or rotate toward each other to close onto the device 102 or to open and reveal the device 102. The front and back portions 106, 104 can be formed from leather, plastic, metal, another material, or a combination of materials.

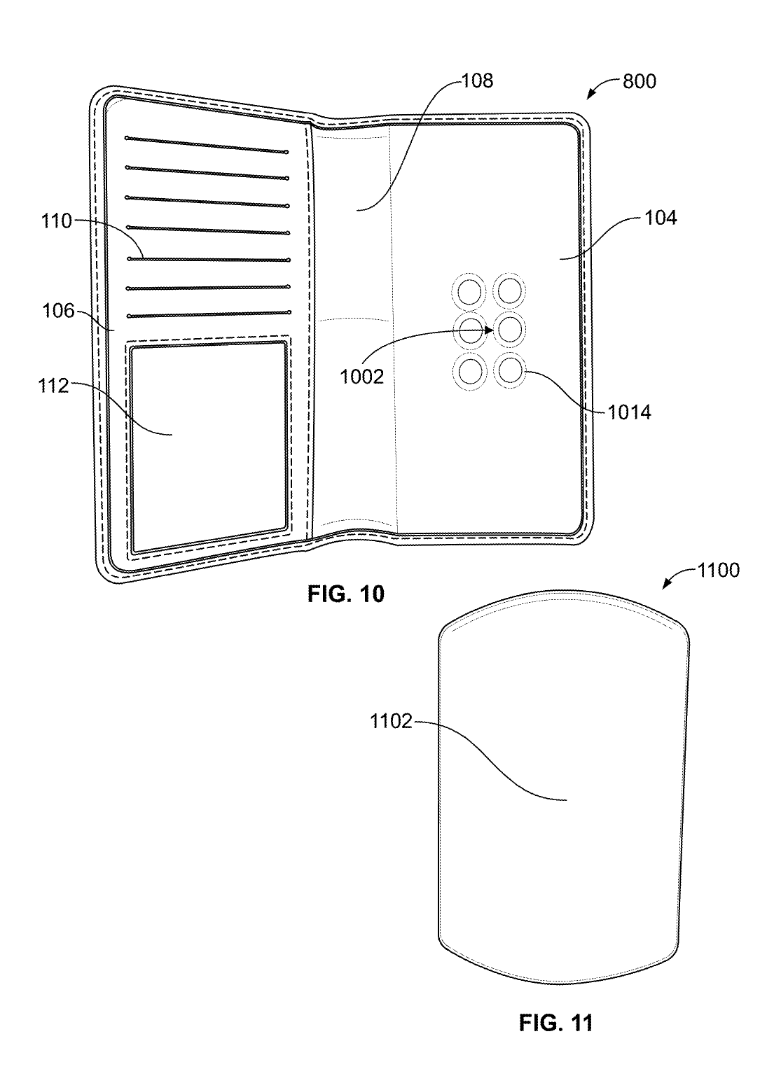

FIG. 10 illustrates the interior of the case assembly 800 shown in FIGS. 8 and 9. The interior of the case assembly 800 includes interior surfaces of the front and back portions 106, 104. The inside of the front portion 106 of the assembly 800 optionally can include one or more of the pockets 110 and/or the protected viewable area 112 for holding other objects, as described above.

The back portion 104 of the assembly 800 includes one or more securing devices 1014. These devices 1014 couple with one or more corresponding or complimentary securing devices on an external surface (e.g., the back side) of the device 102. In the illustrated embodiment, the securing devices 1014 are embedded in the back portion 104. For example, the securing devices 1014 may be magnets that are stitched or otherwise enclosed inside the material or materials forming the back portion 104 of the case assembly 800. Optionally, the securing devices 1014 can be fabric hook-and-loop fasteners that couple the electronic device 102 in the case assembly 800.

With continued reference to the interior surfaces of the case assembly 800 shown in FIG. 10, FIG. 11 illustrates a front view of one embodiment of a securing device 1116 for the electronic device 102. The securing device 1116 is shown in a larger scale in FIG. 11 than the case assembly 800 shown in FIGS. 8 through 10. The securing device 1116 can be a metal or magnetic plate that can magnetically couple with the securing devices 1014 of the case assembly 800. Optionally, the securing device 1116 can be fabric hook-and-loop fasteners that couple with the securing device 1014. The securing device 1116 can include an adhesive layer on a side that is opposite the side shown in FIG. 11. This adhesive layer can be stuck to the back side of the device 102 (e.g., the side of the device 102 that is opposite of the display screen of the device 102) to allow the device 102 to couple with the case assembly 800.

As shown in FIG. 10, the securing devices 1014 can be arranged in a grid or array extending over or beneath part (but not all) of the inside surface of the back portion 104 of the case assembly 800. Alternatively, several more securing devices 1014 may be provided that extend over or beneath a larger portion (or all) of the inside surface of the back portion 104 of the case assembly 800. Providing several securing devices 1014 over or beneath a wide area of the inside surface of the back portion 104 of the case assembly 800 allows for the device 102 to be secured in the case assembly 800 even if the device 102 is not perfectly or exactly centered on the inside surface of the back portion 104 of the case assembly 800. For example, a user may place the device 102 such that a center location 1102 of the securing device 1116 coupled with the device 102 is higher or lower, or left or right, (in the perspective of FIG. 10) than a center location 1002 of the inside surface of the back portion 104 of the case assembly 800.

Additionally, using several separate, spaced-apart securing devices 1014 arranged in a regular or irregular grid or array can ensure that the device 102 does not rotate or move relative to the inside surface of the back portion 104 of the case assembly 800. The securing devices 1014 can be arranged in a regular grid or array when the devices 1014 are a designated distance from each other (e.g., from the nearest neighboring devices 1014). The securing devices 1014 can be arranged in an irregular grid or array when the devices 1014 are different designated distances from each other (e.g., from the nearest neighboring devices 1014). The securing devices 1014 are spaced apart in that there is a spatial gap around each securing device 1014 and the nearest neighboring securing devices 1014. Have several, spaced-apart securing devices 1014 can prevent the device 102 from inadvertently rotating, sliding, or otherwise moving relative to the inside surface of the back portion 104 of the case assembly 800. For example, the different securing devices 1014 that couple with the securing device of the device 102 can provide multiple, different points of contact and coupling between the case assembly 800 and the device 102. The multiple, different points of contact and coupling increase the force needed to separate the device 102 from the case assembly 800, and also help to prevent rotation or other movement of the device 102 relative to the case assembly 800 (e.g., relative to having only a single securing device that couples with a securing device of the device 102).

The user can remove the electronic device 102 from the case assembly 800 by pulling the electronic device 102 away from the case assembly 800. This can break the coupling between the securing devices 1014, 1116 so that the electronic device 102 is no longer coupled with the case assembly 800. The coupling between the securing devices 1014, 1116 can be strong enough that the electronic device 102 does not separate from the case assembly 800 without the user pulling the electronic device 102 away from the case assembly 800, but can be weak enough to allow an ordinary or average human user to separate the electronic device 102 from the case assembly 800 without damaging or destroying the securing devices 1014, 1116, electronic device 102, and/or back portion 104 of the case assembly 800.

Optionally, the securing devices 1116 on the electronic device 102 can be coupled with securing devices 1014 on another assembly or component. For example, another case assembly may have the securing devices 1014 for coupling with the securing device 1016 on the electronic device 102, a car mount assembly may have the securing devices 1014 for coupling with the securing device 1116 on the electronic device 102, a recharging station of the electronic device 102 may have the securing devices 1014 for coupling with the securing devices 1116 on the electronic device 102, or the like.

The size, number, and arrangement of the securing devices 1014, 1116 are provided as one example. Other options for the securing devices 1014, 1116 are shown and described herein. Not all embodiments of the inventive subject matter described herein, however, are limited by the depicted embodiments.

In one embodiment, a case assembly includes a front portion and a back portion affixed with the front portion by an interface. The front and back portions are configured to move toward or away from each other about the interface. The case assembly also includes one or more securing devices affixed with the back portion. The one or more securing devices are configured to removably couple with one or more other securing devices on an electronic device. The one or more securing devices on the back portion are configured to hold the electronic device within the case assembly while allowing the electronic device to be separated from the case assembly.

Optionally, the front and back portions are configured to pivot relative to each other about or around the interface to open or close the case assembly.

Optionally, the front and back portions are configured to move toward each other to close with the electronic device disposed between the front and back portions.

Optionally, the one or more securing devices affixed with the back portion are configured to be magnetically coupled with the one or more other securing devices connected with the electronic device.

Optionally, the one or more securing devices affixed with the back portion are configured to be coupled with the one or more other securing devices connected with the electronic device using a fabric hook-and-loop connection.

Optionally, the one or more securing devices affixed with the back portion are configured to be removably coupled with the one or more other securing devices connected with the electronic device such that the electronic device can be separated from the case assembly without damaging the one or more securing devices or the one or more other securing devices.

Optionally, the front and back portions are sized to receive a variety of different sized electronic devices that are removably coupled with the one or more securing devices.

Optionally, the one or more securing devices are one or more elongated bars.

Optionally, the one or more securing devices are one or more circular discs.

Optionally, the one or more securing devices are one or more shapes with information one or more of embossed or printed thereon.

Optionally, the one or more securing devices have one or more shapes of a team mascot.

In one embodiment, a case assembly includes a front portion and a back portion affixed with the front portion by an interface. The front and back portions are configured to move toward or away from each other about the interface. The case assembly also includes one or more magnetic devices affixed with the back portion. The one or more magnetic devices are configured to magnetically couple with one or more securing devices on an electronic device. The one or more magnetic devices on the back portion are configured to hold the electronic device within the case assembly while allowing the electronic device to be separated from the case assembly.

Optionally, the front and back portions are configured to pivot relative to each other about or around the interface to open or close the case assembly.

Optionally, the front and back portions are configured to move toward each other to close with the electronic device disposed between the front and back portions.

Optionally, the one or more magnetic devices affixed with the back portion are configured to be removably coupled with the one or more securing devices connected with the electronic device such that the electronic device can be separated from the case assembly without damaging the one or more magnetic devices or the one or more securing devices.

Optionally, the front and back portions are sized to receive a variety of different sized electronic devices that are removably coupled with the one or more magnetic devices.

Optionally, the one or more magnetic devices are one or more elongated bars.

Optionally, the one or more magnetic devices are one or more shapes with information one or more of embossed or printed thereon.

Optionally, the one or more magnetic devices have one or more shapes of a team mascot.

In one embodiment, a case assembly includes a front portion and a back portion affixed with the front portion by an interface. The front and back portions are configured to move toward or away from each other about the interface. The case assembly also includes one or more securing devices affixed with the back portion. The one or more securing devices are configured to removably couple with one or more other securing devices on an electronic device. The one or more securing devices on the back portion are configured to hold the electronic device within the case assembly while allowing the electronic device to be separated from the case assembly. The one or more securing devices affixed with the back portion are configured to be coupled with the one or more other securing devices connected with the electronic device using a fabric hook-and-loop connection.

Optionally, the front and back portions are configured to pivot relative to each other about or around the interface to open or close the case assembly.

Optionally, the front and back portions are configured to move toward each other to close with the electronic device disposed between the front and back portions.

Optionally, the one or more securing devices affixed with the back portion are configured to be removably coupled with the one or more other securing devices connected with the electronic device such that the electronic device can be separated from the case assembly without damaging the one or more securing devices or the one or more other securing devices.

Optionally, the front and back portions are sized to receive a variety of different sized electronic devices that are removably coupled with the one or more securing devices.

Optionally, the one or more securing devices are one or more elongated bars.

Optionally, the one or more securing devices are one or more shapes with information one or more of embossed or printed thereon.

Optionally, the one or more securing devices have one or more shapes of a team mascot.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the disclosed subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the inventive subject matter to enable a person of ordinary skill in the art to practice the embodiments of inventive subject matter, including making and using any devices or systems and performing any incorporated methods. The patentable scope of the inventive subject matter is defined by the claims, and may include other examples that occur to a person of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described systems and methods, without departing from the spirit and scope of the inventive subject matter herein involved, it is intended that all of the subject matter of the above description or shown in the accompanying drawings shall be interpreted merely as examples illustrating the inventive concept herein and shall not be construed as limiting the inventive subject matter.

What is claimed is:

1. A case assembly comprising:
a front portion;
a back portion affixed with the front portion by an interface, the front and back portions configured to move toward or away from each other about the interface; and
one or more securing devices affixed with the back portion, the one or more securing devices configured to removably couple with one or more other securing devices on an electronic device, wherein the one or more securing devices on the back portion are configured to hold the electronic device within the case assembly while allowing the electronic device to be separated from the case assembly.

2. The case assembly of claim 1, wherein the front and back portions are configured to pivot relative to each other about or around the interface to open or close the case assembly.

3. The case assembly of claim 1, wherein the front and back portions are configured to move toward each other to close with the electronic device disposed between the front and back portions.

4. The case assembly of claim 1, wherein the one or more securing devices affixed with the back portion are configured to be magnetically coupled with the one or more other securing devices connected with the electronic device.

5. The case assembly of claim 1, wherein the one or more securing devices affixed with the back portion are configured to be coupled with the one or more other securing devices connected with the electronic device using a fabric hook-and-loop connection.

6. The case assembly of claim 1, wherein the one or more securing devices affixed with the back portion are configured to be removably coupled with the one or more other securing devices connected with the electronic device such that the electronic device can be separated from the case assembly without damaging the one or more securing devices or the one or more other securing devices.

7. The case assembly of claim 1, wherein the front and back portions are sized to receive a variety of different sized electronic devices that are removably coupled with the one or more securing devices.

8. The case assembly of claim 1, wherein the one or more securing devices are one or more elongated bars.

9. The case assembly of claim 1, wherein the one or more securing devices are one or more shapes with information one or more of embossed or printed thereon.

10. The case assembly of claim 1, wherein the one or more securing devices have one or more shapes of a team mascot.

11. A case assembly comprising:
a front portion;
a back portion affixed with the front portion by an interface, the front and back portions configured to move toward or away from each other about the interface; and
one or more magnetic devices affixed with the back portion, the one or more magnetic devices configured to magnetically couple with one or more securing devices on an electronic device, wherein the one or more magnetic devices on the back portion are configured to hold the electronic device within the case assembly while allowing the electronic device to be separated from the case assembly.

12. The case assembly of claim 11, wherein the front and back portions are configured to pivot relative to each other about or around the interface to open or close the case assembly.

13. The case assembly of claim 11, wherein the front and back portions are configured to move toward each other to close with the electronic device disposed between the front and back portions.

14. The case assembly of claim 11, wherein the one or more magnetic devices affixed with the back portion are configured to be removably coupled with the one or more securing devices connected with the electronic device such that the electronic device can be separated from the case assembly without damaging the one or more magnetic devices or the one or more securing devices.

15. The case assembly of claim 11, wherein the front and back portions are sized to receive a variety of different sized electronic devices that are removably coupled with the one or more magnetic devices.

16. The case assembly of claim 11, wherein the one or more magnetic devices are one or more elongated bars.

17. The case assembly of claim 11, wherein the one or more magnetic devices are one or more shapes with information one or more of embossed or printed thereon.

18. The case assembly of claim 11, wherein the one or more magnetic devices have one or more shapes of a team mascot.

19. The case assembly of claim 11, wherein the one or more magnetic devices are several spaced-apart circular discs.

20. A case assembly comprising:
a front portion;
a back portion affixed with the front portion by an interface, the front and back portions configured to move toward or away from each other about the interface; and
one or more securing devices affixed with the back portion, the one or more securing devices configured to removably couple with one or more other securing devices on an electronic device, wherein the one or more securing devices on the back portion are configured to hold the electronic device within the case assembly while allowing the electronic device to be separated from the case assembly,
wherein the one or more securing devices affixed with the back portion are configured to be coupled with the one or more other securing devices connected with the electronic device using a fabric hook-and-loop connection.
